(19) United States
(12) Patent Application Publication
(10) Pub. No.: US 2012/0239511 A1
(43) Pub. Date: Sep. 20, 2012

(54) Automated Graphical Advertisement Size Compatibility and Link Insertion

(75) Inventors: Wesley Chan, Seattle, WA (US); Sumit Agarwal, Washington, DC (US); Leora Ruth Wiseman, Zichron Yaakov (IL); Amy Koch, Los Angeles, CA (US); Rama Ranganath, San Francisco, CA (US)

(73) Assignee: GOOGLE INC., Mountain View, CA (US)

(21) Appl. No.: 13/483,029

(22) Filed: May 29, 2012

Related U.S. Application Data
(63) Continuation of application No. 10/841,827, filed on May 10, 2004.

(51) Int. Cl. G06Q 30/02

(52) U.S. Cl. 705/14.72

(57) ABSTRACT

A system for and method of forming graphical advertisements is presented. The disclosed techniques ensure that the graphical advertisements are compatible with available space and industry-standard sizing. The techniques further allow for insertion of a link into the graphical advertisement, where the link is configured such that an activating user will not receive unwanted material.

### FIELD OF THE INVENTION

This invention relates to automatically forming graphical advertisements.

### BACKGROUND OF THE INVENTION

Techniques for manually providing graphical advertisements are known. Such techniques typically involve generating a suitable advertisement, populating it with relevant information, and displaying it for an end user to view. Such techniques suffer from a lack of automation, which presents substantial burdens on advertisement developers' resources.

### SUMMARY OF THE INVENTION

According to an embodiment of the present invention, a method of forming graphical advertisements is presented. The method includes receiving a document, the document being of a first size. A graphical advertisement is formed using the document, the graphical advertisement being of a second size. A link associated with at least a portion of the graphical advertisement is included.

According to another embodiment of the present invention, a system for generating a graphical advertisement is presented. The system includes a connection to a network and a network server configured to accept a document, a first link, and a second link. The system also includes a computer operatively coupled to the connection. The computer is configured to receive the document, the first link, and the second link, to form a graphical advertisement based on the document, the first link, and the second link, and to produce the graphical advertisement. The first link directs a user to vendor information upon activation and the second link allows a user to provide feedback.

According to another embodiment of the present invention, a method of forming a graphical advertisement is presented. The method includes receiving a document, receiving a first link, a second link, and a third link, and forming a graphical advertisement based on the document. The method further includes including the first link on the document, where a user activating the first link directs the user's navigation application in accordance with the second link. A user activating the third link allows the user to provide feedback. The method further includes producing the graphical advertisement to be displayed to a user.

According to another embodiment of the present invention, a method of forming graphical documents is presented. The method includes receiving a first document and forming a graphical document using the first document. At least one link is included on a designated portion of the graphical document. The graphical document is produced to be displayed to at least one end user, where the act of producing includes one or both of displaying the graphical document and transferring the graphical document to an entity for display of the graphical advertisement.

According to another embodiment of the present invention, a method of forming a graphical advertisement is presented. The method includes providing a document, providing a text string, and providing a link. A graphical advertisement is received, the graphical advertisement being based on the document, the first link, and the text string. The graphical advertisement is approved. Activating the text string directs an end user's viewing application in accordance with the link.

The accompanying drawings, which are incorporated in and constitute a part of this specification, illustrate various embodiments of the invention and, together with the description, serve to explain the principles and advantages of the invention.

### BRIEF DESCRIPTION OF THE DRAWINGS

The present invention is further described in the detailed description which follows, in reference to the noted plurality of drawings by way of non-limiting examples of certain embodiments of the present invention, in which like numerals represent like elements throughout the several views of the drawings, and wherein:

FIG. 1 is a flow diagram depicting a graphical advertisement formation process according to an embodiment of the present invention;

FIG. 2 depicts a graphical advertisement creation interface according to an embodiment of the present invention;

FIG. 3 depicts a graphical advertisement formation system according to an embodiment of the present invention;

FIG. 4 depicts a graphical advertisement according to an embodiment of the present invention;

FIG. 5 depicts a graphical advertisement according to an embodiment of the present invention;

FIG. 6 depicts a graphical advertisement according to an embodiment of the present invention; and

FIG. 7 depicts a networked environment for a graphical advertisement formation system according to an embodiment of the present invention.

### DETAILED DESCRIPTION OF VARIOUS EMBODIMENTS

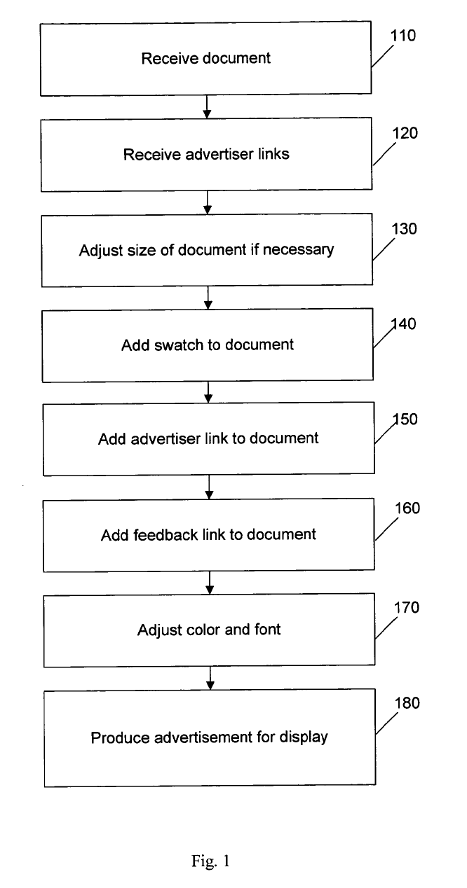

FIG. 1 is a flow diagram depicting a graphical advertisement formation process according to an embodiment of the present invention. More particularly, FIG. 1 depicts graphical advertisement formation that ensures size compatibility and proper link insertion. While the processes and systems described herein relate to graphical advertisements, it should be appreciated that these processes and systems may also be employed for other electronic documents. As used herein, the term “document” and “electronic document” may encompass one or more advertisements, content pages (e.g., web pages), search results, emails, applications, instant messenger messages, audio content or files, video content or files, other files, other data or applications that may reside on one or several (e.g., a network) computer systems, or other definable concepts or content. Although an “image” or “image advertisement” is often used herein as an exemplary document, it should be understood that any document may be used. In one act in the process, an advertiser may provide or produce a document that depicts the advertiser's preferred background for the graphical advertisement. Here, the advertiser may be any entity that produces a document used to form a graphical advertisement. The advertiser may or may not be the same entity that sells the advertised goods or service (the vendor). By way of non-limiting example, the advertiser may act on behalf of the vendor to advertise the vendor's products or services. The document may be a web page, a tangible paper document, a photograph, an electronic graphical file, a video file, or other datum or application. The advertiser may convey the document to the process by way of, for example, email, FTP, regular mail, or other delivery mode. The document is received at block 110.

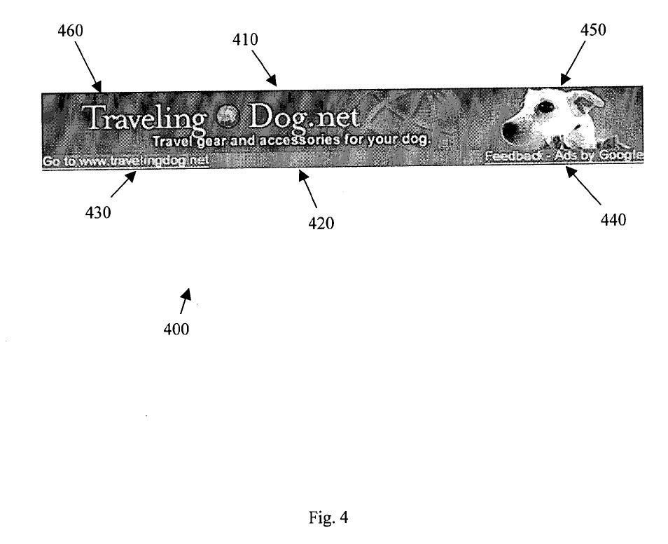

At block 120, one or more of a display link and/or a destination link may be received from the advertiser or other party interacting with the process. The display link may be a text string that represents a uniform resource locator (“URL”), or any other identifier of a resource on a network. As described further below in reference to FIGS. 4-6, the display link may then be displayed on the fully-formed graphical advertisement. The destination link may comprise a text string that represents a URL or other resource identifier. The destination link may be used to direct a user's viewer application to a resource that contains information relating to the goods or services advertised by the fully-formed graphical advertisement. One exemplary implementation of the relationship between the display link and the destination link is described below in reference to FIGS. 4-6. In general, the network on which this resource appears may be an intranet, the internet, a systems network architecture (“SNA”) network, or any other network. The resource itself may be a web page, FTP portal, or other network service or resource.

At block 130, the size of the document may be adjusted, if necessary, to meet preferred dimensions. This adjustment process may involve transforming the document into an appropriate electronic format, such as bitmap, graphics interchange format (“GIF”), joint photographic expert's group (“JPEG”) format, or portable network graphics (“PNG”) format. Such transformation maybe used when, for example, the document arrives as a drawing on tangible paper. Once the document is in electronic form, its size may be adjusted. The size adjustment may be accomplished by a variety of techniques. By way of non-limiting example, the document may simply be cropped by removing portions of the document to reduce its overall size or change its proportions. Alternately, or in addition, the document may be scaled or compressed. Scaling or compression may be accomplished by duplicating or removing pixels, with or without interpolation. Scaling may also be used to change the document's proportion by scaling along an axis. Scaling thus allows for the possibility of both increasing and decreasing the size of the graphical advertisement in one or more dimensions. Such scaling or compression may be accomplished by using a software package or language, such as PHOTOSHOP or JAVA.

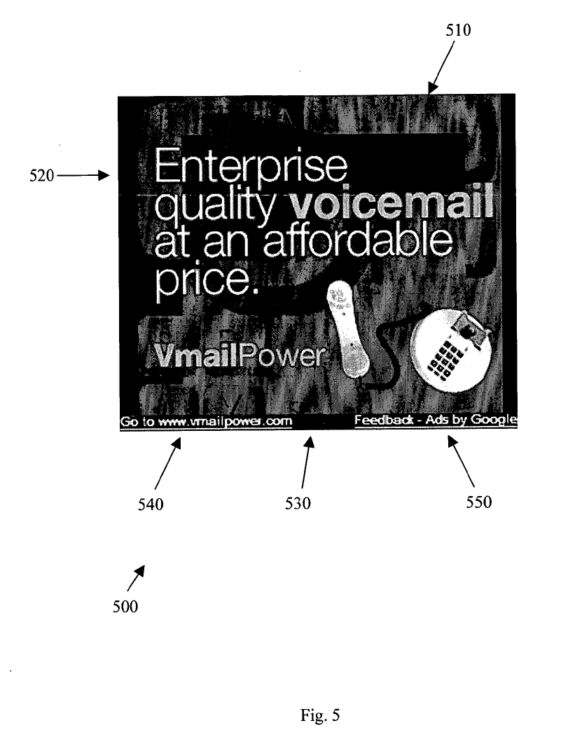

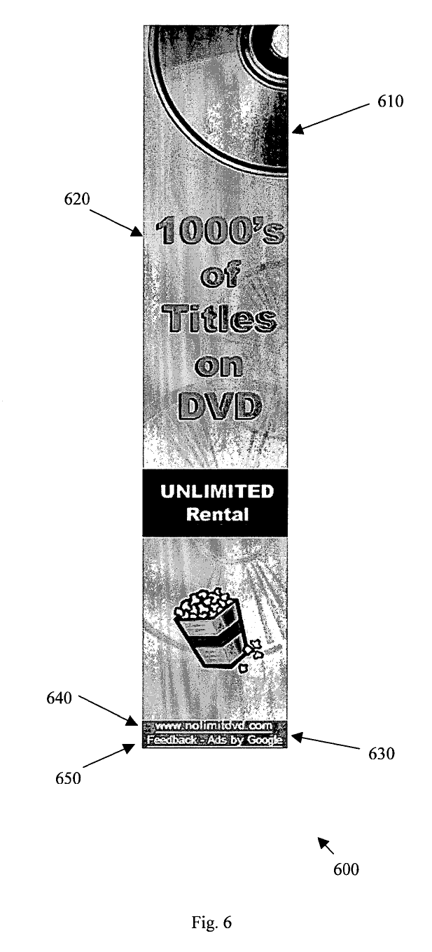

Many factors govern the particular size of the final graphical advertisement. Among these factors are industry standards, advertiser or seller preferences, and agreements, such as partnering agreements, with the entity that is to display the graphical advertisement. By way of non-limiting example, the size of the final graphical advertisement may be rectangular with dimensions measured in terms of pixels. Such dimensions may include, again by way of non-limiting example: 468×60 (a typical banner advertisement, see FIG. 4), 120×600 (a “skyscraper” advertisement, see FIG. 6), 300×250 (an “inline” advertisement, see FIG. 5), or 728×90 (a “leaderboard” advertisement).

At block 140, a swatch may be added to the graphical advertisement. Such a swatch may comprise a portion of the graphical advertisement that is set off from the rest of the image. Also, such a swatch may be sized so as to be capable of containing the display link conveyed at block 120 and a feedback link, described further below in reference to FIGS. 4-6. The swatch may, in one illustrative embodiment, appear at the lowermost portion of the graphical advertisement, and may be just large enough to contain the aforementioned links. However, other locations, such as by way of non-limiting example, at the top portion of the graphical advertisement or vertically on either side are also contemplated. At blocks 150 and 160, the display link and/or feedback link, respectively, may be added to the swatch. The display link and the feedback link may appear on the same horizontal plane or may be vertically stacked if both are included. Other arrangements are also possible.

At block 170, the color and font of the swatch and links appearing therein may be adjusted so as to promote readability by an end user. Various techniques exist and are appropriate for choosing the colors of the swatch and font. By way of non-limiting example, such techniques include: rescaling the pixel intensity to improve contrast, employing PHOTOSHOP tools, and accounting for various psycho-optical considerations. By way of non-limiting example, such psycho-optical considerations include: accounting for the color differentiation ability of the human eye as a function of brightness, accounting for the human eye's ability to better distinguish brightness than color, accounting for pixel granularity compared with vision granularity, and accounting for the fatiguing effect of various color combinations. By way of non-limiting example, these considerations may lead to adjusting font and background color in order to ensure that they differ in both brightness and color to achieve a 180 degree differential, in one illustrative embodiment.

At block 180, a completed graphical advertisement may be produced. The producing process may be direct. For example, the process may immediately post the graphical advertisement in a forum where one or more end users can view it. Such posting may be automated and/or guided by advertiser preferences. The server may act as a graphical advertisement provider consistent with this example. Alternately, or in addition, the delivery process may be indirect. Such an indirect delivery may involve a human component, such as a judgment as to the appropriateness of posting the graphical advertisement in a particular forum. One system and method for judging appropriateness of the graphic advertisement may include that described in co-pending U.S. patent application Ser. No. ______ (Attorney Docket No. 64557.000024), entitled “System and Method for Rating Documents Comprising an Image,” filed May 10, 2004, the subject matter of which is incorporated by reference herein in its entirety.

The completed graphical advertisement may be presented to the advertiser or seller for approval before posting. The completed graphical advertisement may undergo a financial vetting process, whereby it is subjected to market consideration in order to choose a posting forum. By way of non-limiting example, producing block 180 may include submitting the competed graphical advertisement to an auction where its placement is determined by one or more bidding prices. Or the producing may simply involve making the completed graphical advertisement available to an interested party such as the seller, advertiser, or provider. The third party may receive the graphical advertisement by way of, e.g., by email or by posting on a password-secured web site, and may subsequently post the graphical advertisement in a forum where it may be viewed by an end user.

The graphical advertisements produced according to the techniques disclosed herein may be made available to end users in variety of forums. By way of non-limiting example, graphical advertisements produced using the techniques described herein may be utilized with the targeted systems and methods described in co-pending U.S. patent application Ser. No. 10/742,791 (Attorney Docket No. 64557.000011) filed Dec. 23, 2003, entitled “Method and System for Providing Targeted Graphical Advertisements,” the subject matter of which is incorporated by reference herein in its entirety. Thus, a decision as to whether to include a graphical advertisement in a particular forum may be based on whether the products or services advertised by the graphical advertisement are appropriate for the forum. Such a decision may be based on the content of the forum, which may be, for example, a web page. Alternately, or in addition, a graphical advertisement may be displayed on a search-results page or in response to a query. Such a placement may take into account key words and/or pricing parameters.

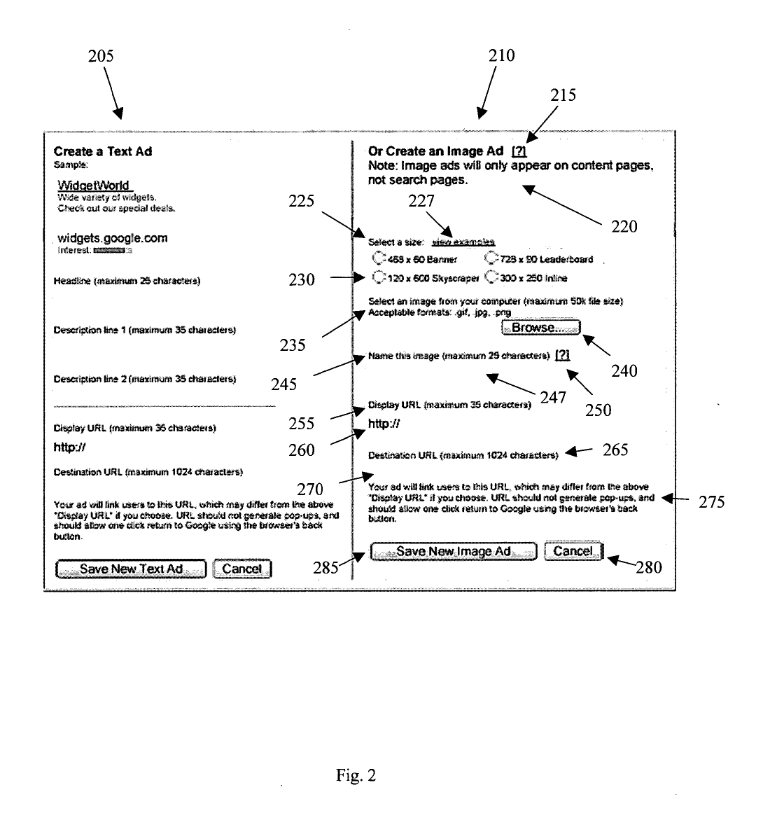

FIG. 2 depicts a graphical advertisement creation interface according to an embodiment of the present invention. More particularly, FIG. 2 depicts a portion of an interface that allows an advertiser to convey a document to an embodiment of the present invention for conversion into a graphical advertisement. The interface depicted in FIG. 2 includes portion 205 for creating a text advertisement and portion 210 for creating a graphical advertisement. Features of portion 210 are discussed herein. Portion 210 includes help link 215, which may be activated to convey information relating to the creation of a graphical advertisement and its associated costs. Portion 210 preferably includes disclaimer 220 notifying a viewer that graphical advertisements formed in conjunction with portion 210 may appear only in certain forums, if applicable. By way of non-limiting example, such a forum may be content web pages as opposed to web pages that depict search results. Portion 210 includes a size-selection portion, which is preferably identified as such using a title 225. The size selection portion may further include link 227 that provides viewers with sample size representations when activated.

The graphical advertisement creation interface of FIG. 2 includes tools for acquiring a document electronically from a user. Identifying text 235 instructs a user to upload an electronic image. Text 235 may identify appropriate file types, such as GIF, JPEG, PNG, or bitmap. Text 235 may also identify limitations on the file size. Text 235 may alternately, or in addition, contain instructions for sending a physical representation of the document through mail or other communication channels. Button 240 allows a user to browse the user's computer to locate and select the document. More particularly, activating button 240 triggers the user's computer to run functionality for navigating the computer's file hierarchy and selecting the document. Text 245 instructs the user to provide the file with a name, which may be entered through field 247. Help link 250 provides the user with information relating to naming the document file when activated.

The graphical advertisement creation interface of FIG. 2 may include tools for accepting a display link and/or a destination link. Text 255 instructs a user to enter a display link at field 260. Text 255 may therefore read, by way of non-limiting example, “Enter a link to be displayed on the finished advertisement (maximum 25 characters).” Text 265 instructs a user to enter a destination link at field 270. As discussed above, either or both of source link and the destination link may be URLs. Text 275 alerts users that the display link will be displayed on the graphical advertisement and that the display link and the destination link need not be identical. Text 275 further indicates to users that activation of the display link on the finalized graphical advertisement may result in the user's viewing application being directed in accordance with the destination link. Portion 210 may also include text 275 that instructs users that activating the destination links should not result in pop-up windows and should allow for one-click return to the point of origin. Finally, button 285 may allow users to save their entries in portion 210, and button 280 allows users to cancel the activity without saving information.

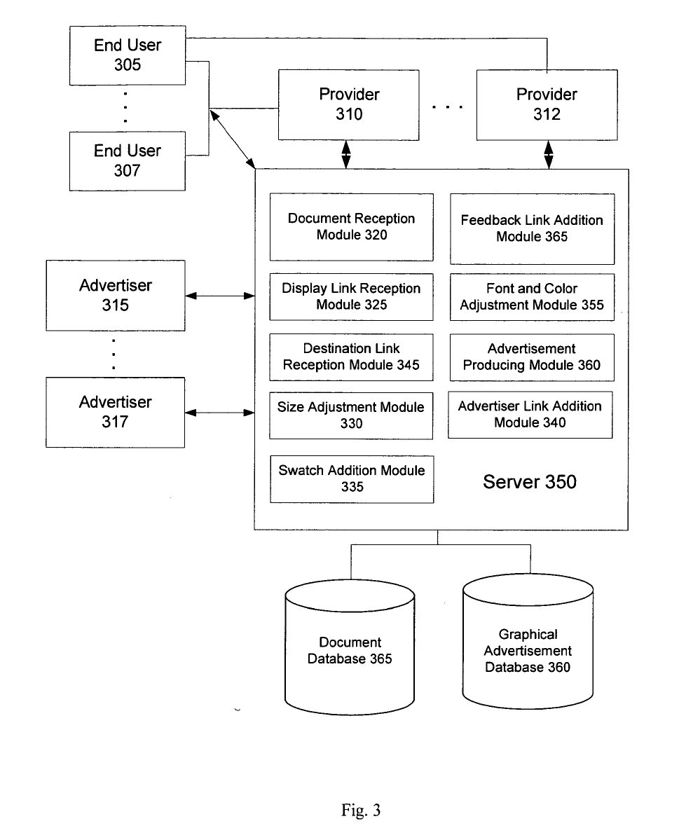

FIG. 3 depicts a graphical advertisement formation and provision system according to an embodiment of the present invention. Server 350, by way of non-limiting example, houses much of the functionality of an embodiment of the present invention. In particular, server 350 provides functionality through a combination of hardware and software. The hardware portion of server 350 includes standard computer hardware such as a computer and connections required to receive and deliver information. The software portion of server 350 allows for flexibility and customization of functionality. Server 350 includes document reception module 320, which controls processing relating to receiving a document from a user. Document reception module 320 may thus provide the functionality described above at 110 of FIG. 1. Server 350 also includes display link reception module 325 and destination link reception module 345. These two modules provide the functionality required to receive and store the display link and destination link, respectively. Thus, these two modules may provide the functionality described above at blocks 150 and 160, respectively, in reference to FIG. 1. Collectively, document reception module 320, display link reception module 325, and destination link reception module 345 provide functionality as illustrated, by way of non-limiting example, by portions 240, 260, and 270 of FIG. 2.

Server 350 may include modules for forming a finalized graphical advertisement. Thus, server 350 includes size adjustment module 330. Size adjustment module 330 provides, by way of non-limiting example, the functionality described above in reference to block 130 of FIG. 1. In particular, size adjustment module decides whether size adjustment is required and implements such adjustment if the decision is in the affirmative. Server 350 also includes swatch addition module 335, which provides, by way of non-limiting example, the functionality described above in reference to block 140 of FIG. 1. Advertiser link addition module 340 and feedback link addition module 365 provide, by way of non-limiting example, the functionality described above in reference to blocks 150 and 160, respectively, of FIG. 1. Font and color adjustment module 355 provides, by way of non-limiting example, the functionality described above in reference to block 170 of FIG. 1. Once modules 330, 335, 340, 355, and 365 form a graphical advertisement using data received by modules 320, 325, and 345, advertisement producing module 360 produces the finalized graphical advertisement in accordance with, by way of non-limiting example, block 180 of FIG. 1.

Server 350 may be operatively connected to a variety of entities. Advertiser systems 315 and 317 may be coupled to and interact with server 310 through, by way of non-limiting example, the internet. Advertisers are thus able to convey documents (through e.g., document reception module 320), display links (through e.g., display link reception module 325), and destination links (through e.g., destination link reception module 345) to server 350. Again by way of non-limiting example, advertisers may interact with server 350 through the graphical advertisement creation interface of FIG. 2. Providers 310 and 312 may be connected to server 350 to receive finalized graphical advertisements. Providers 310 and 312 thus may be charged with making the graphical advertisements available for display to end users 305 and 307 who may purchase the products or services so advertised. Provides 310 and 312 may include, by way of non-limiting example, web page hosts, internet service providers, contractors, business partners, affiliates, and others. End users 305 and 307 may include, by way of non-limiting example, individuals utilizing a viewing application on hardware connected to a network such as the internet. As shown, server 350 may provide advertisements directly to end users 305, 307. Server 350 may further be connected to document database 365, which may store documents conveyed to server 350 by advertisers 315, 317. Server 350 may also be connected to graphical advertisement database 360, which may store finalized graphical advertisements that are conveyed to providers 310, 312.

As used herein, the term “module” may connote either, or a combination, of hardware or software. The software portion may be a particular portion of executable code, such as an object in an object oriented programming language. The hardware portion may include one or both of processing hardware, such as a central processing unit (“CPU”), and storage hardware, such as random access memory (“RAM”) or read only memory (“ROM”).

FIG. 4 depicts a graphical advertisement 400 according to an embodiment of the present invention. Graphical advertisement 400 may include a document portion 410 and a swatch portion 420. Document portion 410 may be derived from a document supplied by an advertiser through, by way of non-limiting example, block 110 of FIG. 1. Swatch portion 420 may be imposed using the techniques disclosed above in reference to, by way of non-limiting example, block 140 of FIG. 1. Swatch portion 420 may include display link 430 and feedback link 440. By way of non-limiting example, display link 430 may be provided in block 150 of FIG. 1 and feedback link may be provided in block 160 of FIG. 1. Note that graphical advertisement 400 may include both images 450 and text 460 on document portion 410.

An end user may view and interact with graphical advertisement 400 as described presently. An end user may encounter graphical advertisement 400 on, by way of non-limiting example, a web page accessible on the internet or an intranet. The end user will generally first view document portion 410, which is typically designed to attract a potential viewer's attention. The end user will generally next notice swatch potion 420, which stands off from document portion 410 and typically bears a different color or pattern compared with document portion 410. Upon further inspection, the end user will generally notice display link 430 and feedback link 440.

Display link 430 is generally chosen to provide a clear indication of the resource to which an end user will likely be directed upon its activation. Display link 430 may be readable when set against swatch portion 420. Display link 430 may typically illustrate a simple and readable domain name URL. Display link 430 may be formed to resemble a portion of a URL (e.g., omitting the “http://” portion where the resource is accessible by hypertext transfer protocol (“http”)). Display link 430 may be comprised of a common word, or words or phrases concatenated together. Display link 430 may be selected to convey to the end user some amount of confidence that the user's viewer will not be directed to a resource involving pop-up windows, the inability to backtrack, exit windows, or other unpleasant and unintended effects. Thus, display link 430 may provide a simple, clear indication of a simple, clear consequence of its activation.

The end user may choose to activate display link 430. Typically, such activation occurs by the end user “clicking on” display link 430 with a mouse. Other methods of user selection are also possible. The resource to which an end user's viewer is directed upon activation of display link 430 may be identified by a different link. In particular, the resource actually called by activating display link 430 may be identified by a destination link conveyed by an advertiser at block 120 of FIG. 1, or via destination link field 270 of FIG. 2. Display link 430 effectively serves as a “button” that directs a user's viewing application to a resource defined by a destination link. Thus, display link 430 serves as a “public face” for the resource identified by a destination link.

The end user may also activate feedback link 440. Feedback link 440 allows end users and others to comment on any aspect of the finalized graphical advertisement such as its placement, content, or operation. More specifically, feedback link 440 calls up, by way of non-limiting example, a web page where the user may provide feedback, a properly-addressed email using the user's native email application, or a dedicated feedback email web page. The end users' comments may be conveyed to a party that is responsible for the production or placement of the graphical advertisement, such as the producer or provider. Feedback link 440 may identify the party that reviews the comments. Feedback link 440 may identify the entity that generated graphical advertisement 400 from advertiser-supplied information, e.g., as illustrated by FIG. 1. That is, feedback link 440 may identify the graphical advertisement producer. As such, feedback link 440 generally includes the name of the supplier along with language that suggests that activating feedback link 440 will allow an end user to communicate with that entity. By way of non-limiting example, feedback link 440 may read “Feedback—Ads by Google” where GOOGLE supplied graphical advertisement 400. Feedback link 440 may operate with a system and method as described in co-pending patent application Ser. No. ______ (Attorney Docket No. 64557.000024), as mentioned above.

Feedback link 440 may allow the vendor associated with graphical advertisement 400 to share in the good will enjoyed by the entity identified by the feedback link. End users are generally more willing to take a chance with an unfamiliar vendor if that vendor is endorsed by or associated with a known entity. Thus, users that are unfamiliar with the goods or services associated with graphical advertisement 400 or leery of the entity that sells such goods or services may nevertheless activate display link 430 based upon the good will associated with the entity identified by feedback link 440 (e.g., the entity that produces or displays the graphical advertisement).

FIG. 5 depicts a graphical advertisement 500 according to an embodiment of the present invention. Graphical advertisement 500 includes a document portion 510, document portion text 520, a swatch portion 530, a display link 540, and a feedback link 550. Each of these features is analogous to the corresponding feature discussed above in reference to FIG. 4.

FIG. 6 depicts a graphical advertisement 600 according to an embodiment of the present invention. Graphical advertisement 600 includes a document portion 610, document portion text 620, a swatch portion 630, a display link 640, and a feedback link 650. Each of these features is analogous to the corresponding feature discussed above in reference to FIG. 4. Note that display link 640 is positioned above feedback link 650 consistent with the generally vertical appearance of graphical advertisement 600.

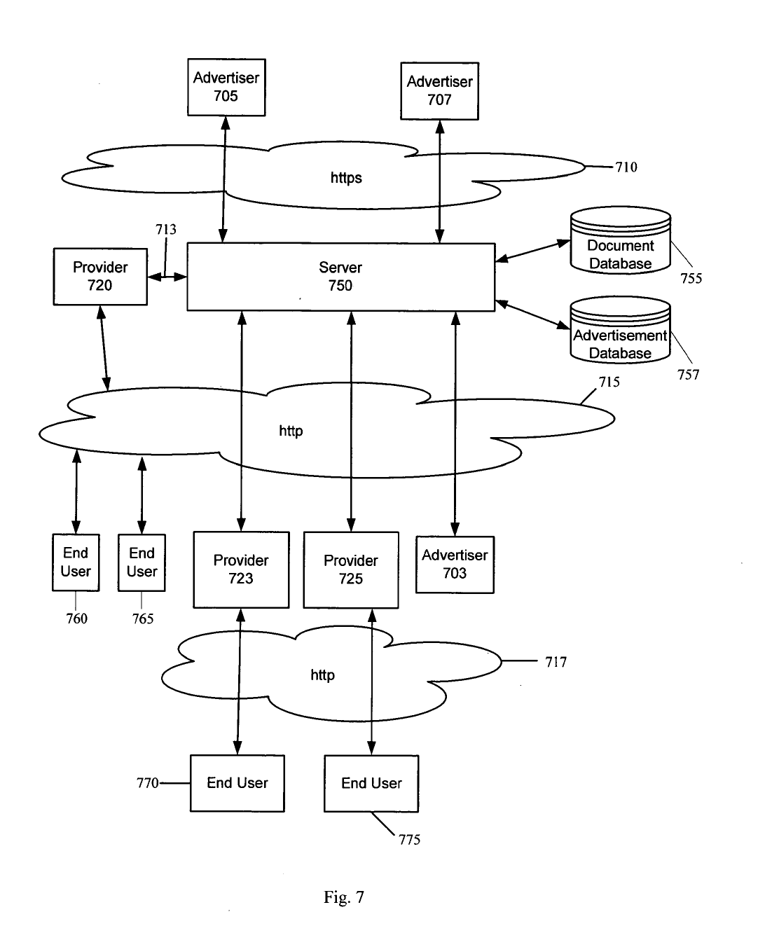

FIG. 7 depicts a networked environment for a graphical advertisement formation system according to an embodiment of the present invention. In such an environment, advertisers 703, 705, 707 may connect over a network 710, 715 to server 750 (using, by way of non-limiting example, a http or secure https connection) to provide documents to server 750. Server 750 may store the received documents in document database 755. Server 750 may produce finalized advertisements to be displayed to an end user through various forums or feeds, including providing the advertisements on one or more web sites affiliated with server 750, via email, by FTP, and through providers 720, 723, and 725. Server 750 may store finalized advertisements in advertisement database 757. Providers may include partners of server 750 (e.g., connected over network 713 or 715), content systems (e.g., with associated content databases), and search engine systems operated by the server 750 or providers 720, 723, 725. Thus, end users 760, 765, 770, 775 may view the finalized graphical advertisements on, for example, web pages hosted by any of server 750, or providers 720, 723, or 725.

Each of server 750, providers 720, 723, 725, and advertisers 703, 705, and 707 may comprise computerized systems that include one or more of the following systems: a web server, a database server, proxy server, network balancing mechanisms and systems, and various software components that enable the system to operate on the interne or other network-type systems. Additionally, networks 710, 713, 715, and 717, may comprise networks such as private lines, intranets, http networks, virtual private networks (“VPN”), the interne, connection-based networks such as a SNA network, or any other network. In an exemplary embodiment, the connection between an advertiser 703, 705, or 707 and server 750 (and other connections such as between a providers 720, 723, and 725 and server 750) may comprise secure network connections to insure that data is not subject to attack or corruption by any hacker or other third party. In addition, whereas three advertisers 703, 705, and 707 are depicted, it should be appreciated that one or more advertisers 703, 705, and 707 may be provided in the network. Similarly, although two databases 755, 757 are depicted, it should be appreciated that one or more databases may be provided and that such databases may be connected to the server 750 via any type of network connection, including a distributed database server architecture.

Similarly, providers 720, 723, and 725 may comprise any number of such systems connected to server 750 via any type of network, including but not limited to an http, https, or VPN network. Providers 720, 723, and 725 may comprise systems such as server 750 that provides functionality for enabling connection over the interne or other network. End users 760, 765, 770, and 775 may comprise any user (such as users connected to the internet) and may comprise computerized systems that enable that connection through any of various types of networks, including through interne service providers, cable companies, and any other method of accessing data on the interne. Providers 720, 723, and 725 may comprise any system that distributes content such as advertising to end-users 760, 765, 770, and 775.

In an embodiment of the present invention, an advertiser provides a document to be used to create a graphical advertisement by supplying a link instead of or in addition to uploading a document. Referring to FIG. 1, at block 110, the advertiser may provide a document to be used for a graphical advertisement. Referring to FIG. 2, as described in reference to button 240, an advertiser may upload a document to be processed into a graphical advertisement. Instead of or in addition to these techniques, an advertiser may convey a link to a resource on a network containing an electronic copy of the document. The resource may be, by way of non-limiting example, a web page or FTP site. Once the advertiser conveys a link identifying the resource and possibly the name of the document file, an embodiment of the present invention automatically directs an application to that resource to retrieve the document. The advertiser may convey the link using, by way of non-limiting example, email, a user interface similar to that depicted in FIG. 2, or even via telephone by voice. Other techniques for delivering the link are also contemplated. The embodiment of the present invention may retrieve the document by “crawling” to the resource identified by the link, locating the document contained therein, and retrieving the document. The document may then be used to create a graphical advertisement according to the techniques disclosed herein.

According to an embodiment of the present invention, foreign languages are accommodated. This may occur at several junctures. An advertiser may chose the language of the user interface, such as that depicted in FIG. 2, with which he or she interacts. This choice may occur by having the advertiser click on appropriately-marked buttons. By way of non-limiting example, the advertiser may be presented with buttons marked “English”, “Espanol”, and “Deutsch.” After selecting the appropriate button, further interactions with the user interface may be presented in the appropriate language. Alternately, or in addition, an embodiment of the present invention may automatically select the appropriate user-interface language. This selection process may occur by mapping origin information, such as an IP address, to known geographical locations. The origin information may be automatically gathered by an embodiment of the present invention, rendering the translation process completely transparent to the advertiser.

In an embodiment of the present invention, the advertiser may be prompted to select one or more languages that the final graphical advertisement will employ. This selection process may occur via a user interface such as that depicted in FIG. 2. Once the advertiser selects the language or languages, an embodiment of the present invention may produce graphical advertisements tailored for each of the languages selected. For example, the display link may be translated by parsing it into its constituent words or phrases and using an automatic translator to convert it into different languages. This process may include manual portions, such as a review by a human translator. Note that the automatic translation may translate word-for-word, or may intelligently translate, accounting for differences in grammar, slang, custom, etc. In addition to the display link, or in the alternative, the feedback link may be translated. As above, the translation process for the feedback link may be automatic, may include manual portions, may be word-for-word, or may be intelligent. Further, the text in the document portion, such as 460, 520, 620 of FIGS. 4, 5, and 6, respectively, may be translated according to these techniques.

While the foregoing description includes details and specificities, it should be understood that such details and specificities have been included for the purposes of explanation only, and are not to be interpreted as limitations of the present invention. Many modifications to the embodiments described above can be made without departing from the spirit and scope of the invention, as it is intended to be encompassed by the attached claims and their legal equivalents.

What is claimed is:

1. A method of forming graphical advertisements, the method comprising:
receiving a document, the document being of a first size;
forming a graphical advertisement using the document, the graphical advertisement being of a second size; and
including a link associated with at least a portion of the graphical advertisement.

2. The method of claim 1 wherein the second size is different from the first size and the act of forming comprises cropping.

3. The method of claim 1 wherein the second size is different from the first size and the act of forming comprises scaling.

4. The method of claim 1 wherein the second size is consistent with an industry standard.

5. The method of claim 1 wherein the portion is assigned a color or pattern.

6. The method of claim 1 wherein the appearance of the link identifies a vendor.

7. The method of claim 1 wherein the appearance of the link identifies a URL.

8. The method of claim 1 wherein a party other than a vendor associated with the advertisement provides the document received by the receiving.

9. The method of claim 1 wherein a feedback link is included in the designated portion.

10. The method of claim 9 wherein the feedback link is identified as being associated with a distributor of the advertisement.

11. The method of claim 9 wherein the appearance of the feedback link identifies a distributor of the advertisement.

12. The method of claim 1 wherein the portion is substantially a different color from the document.

13. The method of claim 1 wherein a color of the link is chosen to promote visibility of the link.

14. The method of claim 1 wherein the act of receiving a document comprises receiving an electronic version of the document.

15. The method of claim 1 wherein the act of receiving a document comprises receiving an electronic document uploaded by a provider.

16. The method of claim 1 wherein the act of receiving a document comprises receiving an identification of a location of the electronic document and retrieving the document identified at the location.

17. The method of claim 1 further comprising the act of receiving an identification of the language for the advertisement.

18. The method of claim 17 further comprising including text in the identified language in the advertisement created.

19. The method of claim 1 wherein the graphical advertisement is placed in a forum according to the content of the forum.

20. A system for forming a graphical advertisement, the system comprising:
receiving means for receiving a document;
forming means for forming a graphical advertisement using the document;
including means for including a link on a designated portion of the graphical advertisement; and
producing means for producing the graphical advertisement to be displayed to at least one potential customer, wherein the producing comprises one or both of displaying the graphical advertisement and transferring the graphical advertisement to an entity for display of the graphical advertisement.

21. A system for generating a graphical advertisement, the system comprising:
a connection to a network;
a network server configured to accept a document, a first link, and a second link; and
a computer operatively coupled to the connection, the computer configured to receive the document, the first link, and the second link, and to form a graphical advertisement based on the document, the first link, and the second link, and to produce the graphical advertisement;
whereby the first link directs a user to vendor information upon activation and the second link allows a user to provide feedback.

22. A method of forming a graphical advertisement, the method comprising:
receiving a document;
receiving a first link, a second link, and a third link;
forming a graphical advertisement based on the document;
including the first link on the document, wherein a user activating the first link directs the user's navigation application in accordance with the second link, and wherein a user activating the third link allows the user to provide feedback; and
producing the graphical advertisement to be displayed to a user.

23. A method of forming graphical documents, the method comprising:
receiving a first document;
forming a graphical document using the first document;
including at least one link on a designated portion of the graphical document; and
producing the graphical document to be displayed to at least one end user, wherein the act of producing comprises one or both of displaying the graphical document and transferring the graphical document to an entity for display of the graphical advertisement.

24. A system for generating a graphical document, the system comprising:
a connection to a network;
a network server configured to accept a first document, a first link, and a second link; and
a computer operatively coupled to the connection, the computer configured to receive the first document, the first link, and the second link, and to form a graphical document based on the first document, the first link, and the second link, and to produce the graphical document;
whereby the first link directs a user to vendor information upon activation and the second link allows an end user to provide feedback.

25. A method of forming a graphical advertisement, the method comprising:
providing a document;
providing a text string;
providing a link;
receiving a graphical advertisement, the graphical advertisement being based on the document, the first link, and the text string; and
approving of the graphical advertisement;
whereby activating the text string directs an end user's viewing application in accordance with the link.

26. A system for forming a graphical advertisement, the system comprising:
a connection to a network; and
a computer operatively coupled to the connection to a network, the computer configured to display an interface, the interface configured to accept a document, a first link, and a text string;
whereby a user providing a document, a first link, and a text string via the interface is provided with a graphical advertisement based on the document, the first link, and the text string.
